(19) United States
(12) Patent Application Publication
(10) Pub. No.: US 2021/0134195 A1
(43) Pub. Date: May 6, 2021

(54) MEMORABILIA BALL SIMULACRUM

(71) Applicant: Lauren Cecchi, New York, NY (US)

(72) Inventor: Lauren Cecchi, New York, NY (US)

(21) Appl. No.: 16/668,014

(22) Filed: Oct. 30, 2019

(51) Int. Cl. G09F 23/00; G09F 7/00

(52) U.S. Cl. CPC G09F 23/00; G09F 7/00

(57) ABSTRACT

A memorabilia ball simulacrum, the memorabilia ball simulacrum comprising: a front side; a rear side on a side opposite the front side, the rear side generally flat and smooth; a plurality indentions on the front side, the plurality of indentions configured to appear like the seams of a ball.

### TECHNICAL FIELD

The present invention relates to a memorabilia ball simulacrum, and more particularly to a memorabilia ball simulacrum that is modified for display and is autographable.

### BACKGROUND

When it comes to collecting autographs of well-known sport celebrities, personalities, and people, collectors have the tendency to use actual sports items used by the person. Sports items such as soccer balls are used for soccer players, footballs for football players, sports uniform jerseys for athletes, and the like. The problem encountered by this practice is the fact that the items may be cumbersome, or the person may not have one readily available to be autographed. One example would be having a soccer ball available for a soccer player to autograph. Individuals may use items such as napkins, scrap pieces of paper, menus or other random items to get autographs. After these items are signed, the majority of them end up being damaged, discarded or put away in a place they cannot be readily displayed and appreciated.

Additional problems faced by people seeking autographs of famous or notable individuals is that they try to have items related to the individual, such as a baseball card with the player's image on it, a picture of the person, or an item related to the signatory, such as a program.

The overall problem faced by individuals who are able to obtain autographs, on random items, is their items are diminished in their collectable values compared to what they might be able to get for autographed sports items for athletes. The item signed can also possibly be easily misplaced, or lost, and not be retained by the collector.

Thus there is a need for a memorabilia ball simulacrum that overcome the above listed and other disadvantages.

### SUMMARY OF THE INVENTION

The invention relates to a memorabilia ball simulacrum, the memorabilia ball simulacrum comprising: a front side; a rear side on a side opposite the front side, the rear side generally flat and smooth; a plurality indentions on the front side, the plurality of indentions configured to appear like the seams of a ball.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front perspective view of the disclosed memorabilia ball simulacrum;

FIG. 2 is a front view of the memorabilia ball simulacrum from FIG. 1;

FIG. 3 is a rear view of the memorabilia ball simulacrum from FIG. 1;

FIG. 4 is a side view of the memorabilia ball simulacrum from FIG. 1; and

FIG. 5 is a bottom view of the memorabilia ball simulacrum from FIG. 1.

### DETAILED DESCRIPTION OF THE INVENTION

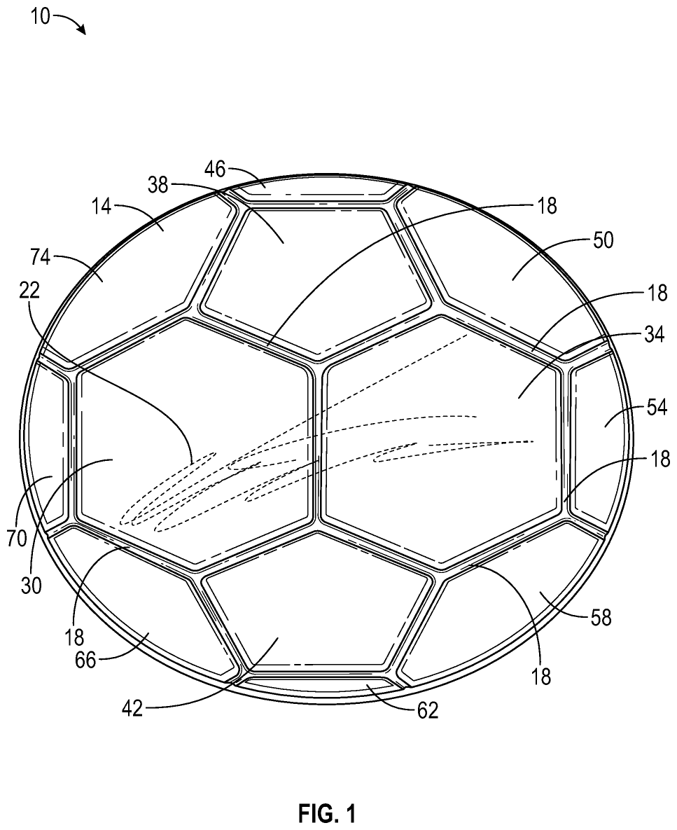

FIG. 1 is a perspective view of one embodiment of the memorabilia ball simulacrum 10. In this embodiment, the ball simulacrum is a soccer ball. However, the memorabilia ball simulacrum may be any type of sports ball or piece of sports equipment such as, but not limited to a basketball, tennis ball, baseball, ping pong ball, rugby ball, baseball bat, tennis racket, pickleball ball, pickleball paddle, ping pong paddle, hockey puck, hockey stick, etc. The memorabilia ball simulacrum is generally flat with a front side 14 and rear side (not visible in this view). The memorabilia ball simulacrum 10 may have seams 18 that correspond to the seams on a soccer ball as generally viewed and generally in perspective. The seams 18 are located on the perimeter of the hexagons and pentagons that a soccer ball may have on its surface. In this embodiment, two full hexagons 30, 34 abut each other. A first full pentagon 38 abuts the two full hexagons 30, 34 from above, and a second full pentagon 42 abuts the two full hexagons 30, 34 from below. The rest of the polygons on the simulacrum 10 are only portions of the polygons as may be seen if the simulacrum were a soccer ball, and the polygons are distorted by the perspective view of the ball, as represented on the simulacrum 10. Moving clockwise from the 12 o′clock position on the simulacrum (at the top position of the simulacrum), the first portion of a polygon at the 12 o′clock position is a hexagon 46, the next polygon, going clockwise, is a hexagon 50, the next polygon is a pentagon 54, the next polygon is a hexagon 58, the next polygon is a hexagon 62, the next polygon is a hexagon 66, the next polygon is a pentagon 70, and the last polygon is a hexagon 74.

The seams 18 are actually indentations or grooves located on the front side 14 of the memorabilia ball simulacrum 10. The seams 18 may have a depth of about 1/40^{th} of an inch to about 1/20^{th} of an inch, or any suitable depth. Also shown on the front side 14, is a representation of a signature 22 of a sports figure or other celebrity. The front side 14 of the memorabilia ball simulacrum 10 is generally flat, except for the seams 18, thus making it suitable for the signature or autograph of a celebrity. The front side 14 may have printed matter on it, such as but not limited to the colors of a particular sports team, the number of a particular athlete, the mascot of a sports team, the emblem of a sports team.

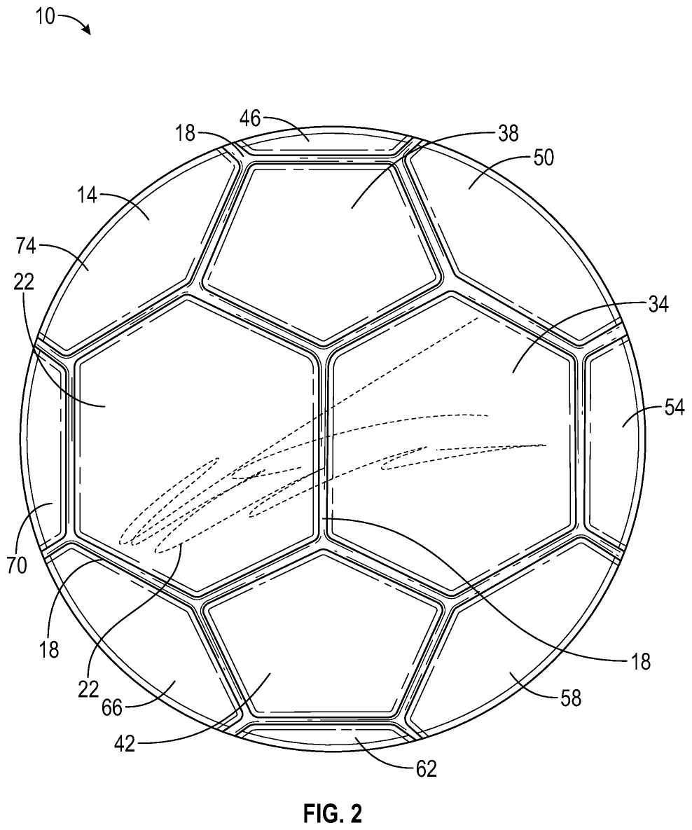

FIG. 2 is a front view of the memorabilia ball simulacrum 10.

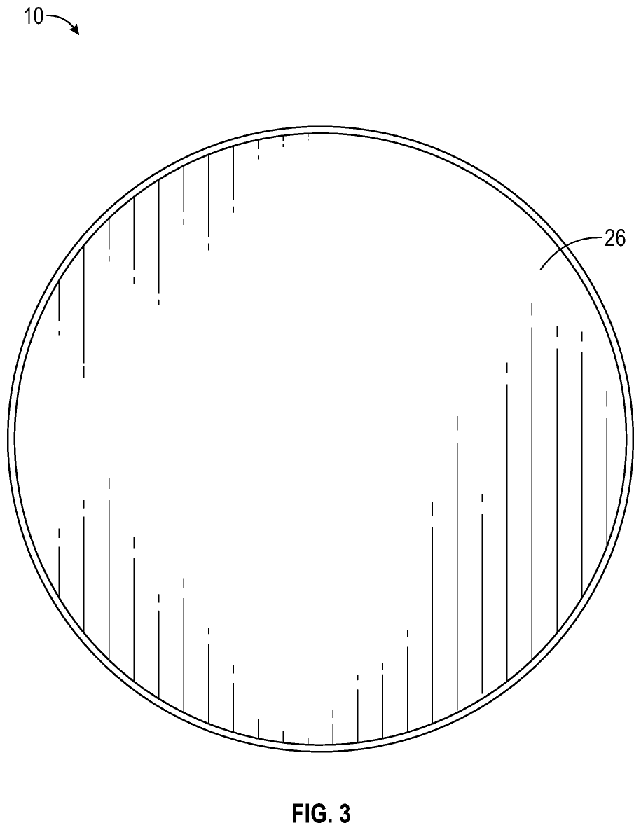

FIG. 3 is a rear view of the memorabilia ball simulacrum 10. In this view the rear side 26 is visible. In one embodiment, the rear side 26 will not have indentations or channels representing seams 18. The rear side 26 may have printed matter, such as details about a particular athlete, such as, but not limited to name, date of birth, sports teams he or she plays on, country the athlete is from, athlete's number, picture of the athlete's team logo, picture of the athlete s team's mascot, athlete's height, athlete's weight, athlete's statistics, etc.

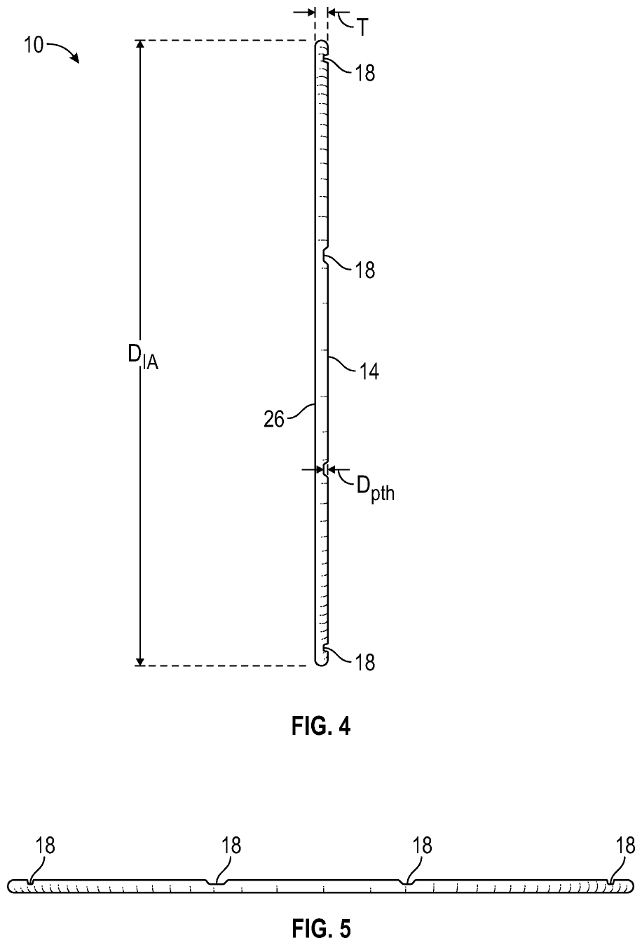

FIG. 4 is a side view of the memorabilia ball simulacrum 10. The seams 18 may have a depth D_{PTH}, and the ball simulacrum 10 may have a diameter D_{IA}, and a thickness T. As stated above, the depth of the seams 18 may be about 1/40^{th} to about 1/20^{th} of an inch, but may be any suitable depth. Dpth may also range from about ⅛th of T to about ½ of T. The memorabilia ball simulacrum may have a D_{IA} of about 4 inches to about 6 inches. In other embodiments, the memorabilia ball simulacrum may have a D_{IA} of about 2 inches to about 12 inches. The thickness T may range from about 0.05 inches to about 0.5 inches.

FIG. 5 is a bottom view of the memorabilia ball simulacrum 10.

The disclosed memorabilia ball simulacrum has many advantages. It is small and flat, and can be carried easily in a pocket and removed in order to obtain an autograph of a celebrity. The memorabilia ball simulacrum looks like a sports ball, and is aesthetically pleasing, and is a collectable item, especially if autographed. The memorabilia ball simulacrum has indentions or channels where the seams of a ball would be, to give the memorabilia ball simulacrum a more realistic look and feel. The memorabilia ball simulacrum has a surface that is configured to allow easy autographing. The memorabilia ball simulacrum can be easily placed in a holder or stand for displaying the memorabilia ball simulacrum.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A memorabilia ball simulacrum, the memorabilia ball simulacrum comprising:
a front side;
a rear side on a side opposite the front side, the rear side generally flat and smooth;
a plurality indentions on the front side, the plurality of indentions configured to appear like the seams of a ball.

2. The memorabilia ball simulacrum of claim 1 further comprising:
a plurality of polygons on the front side;
a plurality of portions of polygons on the front side;
the plurality of indentations located at the perimeter of each polygon and each portions of polygons.

3. The memorabilia ball simulacrum of claim 2, wherein:
the plurality of polygons comprise:
a first hexagon;
a second hexagon abutting the first hexagon;
a first pentagon located above the two hexagons and abutting the two hexagons;
a second pentagon located below the two hexagons, and abutting the two hexagons;
the plurality of portions of polygons comprising:
a portion of a third hexagon abutting the first pentagon;
a portion of a fourth hexagon abutting the portion of the third hexagon, first pentagon and the second hexagon;
a portion of a third pentagon abutting the second hexagon and the portion of the fourth hexagon;
a portion of a fifth hexagon abutting the second hexagon and the portion of the third pentagon;
a portion of a sixth hexagon abutting the second pentagon and the portion of the fifth hexagon;
a portion of a seventh hexagon abutting the portion of the sixth hexagon and the second pentagon;
a portion of a fourth pentagon abutting the portion of the seventh pentagon and the first hexagon;
a portion of an eighth hexagon abutting the portion of the portion of the fourth pentagon and the portion of the third pentagon.

4. The memorabilia ball simulacrum of claim 1, wherein the front side is configured to receive an autograph.

5. The memorabilia ball simulacrum of claim 1, wherein the memorabilia ball simulacrum has a thickness T, and the seams have a depth of Dpth, and wherein Dpth is about ⅛th of T to about ½ of T.

6. The memorabilia ball simulacrum of claim 1, wherein the seams have a depth of Dpth, and wherein Dpth is about 1/40th to about 1/20th of an inch.

7. The memorabilia ball simulacrum of claim 2, wherein the memorabilia ball simulacrum has the appearance of a soccer ball.

8. The memorabilia ball simulacrum of claim 1, wherein the rear side has printed information about an athlete.

9. The memorabilia ball simulacrum of claim 1, wherein the front side has printed information about a sports team.

10. The memorabilia ball simulacrum of claim 8, wherein the front side has printed a player number of the athlete from the rear side.

11. The memorabilia ball simulacrum of claim 1, wherein the memorabilia ball simulacrum has a thickness T, and the seams have a depth of Dₚₜₕ, and the memorabilia ball simulacrum has a diameter Dᵢₐ, and wherein Dₚₜₕ is about 0.05 inches to about 0.025 inches, T is about 0.05 inches to about 0.5 inches, and Dᵢₐ is about 4 inches to about 6 inches.
